(19) United States
(12) Patent Application Publication
(10) Pub. No.: US 2015/0377522 A1
(43) Pub. Date: Dec. 31, 2015

(54) Support member with dual use rebar for geothermal above ground loop

(71) Applicant: Mark R. Ziegenfuss, Ringoes, NJ (US)

(72) Inventor: Mark R. Ziegenfuss, Ringoes, NJ (US)

(73) Assignee: Ziegenfuss Holdings, LLC

(21) Appl. No.: 14/121,061

(22) Filed: Jul. 25, 2014

Related U.S. Application Data
(63) Continuation-in-part of application No. 14/120,780, filed on Jun. 26, 2014.

(51) Int. Cl. F24J 3/08; B28B 5/00

(52) U.S. Cl. CPC F24J 3/081; B28B 5/00; F24J 2003/088

(57) ABSTRACT

A support member for a man-made structure, such as a roadway, building, runway, bridge, includes a poured filler and at least two hollow rebars embedded within the filler displacing a volume of filler equal to the volume of the embedded rebars, a first hollow rebar being a inward flow geothermal above ground loop segment, and a second hollow rebar being an outward flow geothermal above ground loop segment, the two hollow rebars being connected to each other by a hollow connector to establish a geothermal above ground loop, the rebars having structural design support sufficient to support load in excess of displaced filler.

### REFERENCE TO RELATED APPLICATIONS

The present application is a continuation-in-part of co-pending U.S. patent application Ser. No. 14/120,780 titled “Support Member With Dual Use Rebar For Geothermal Below Ground Loop” filed on Jun. 26, 2014 by the present inventor herein.

### BACKGROUND OF INVENTION

a. Field of Invention

The present invention generally relates to geothermal conditioning systems for air conditioning, heating and combinations thereof. Such systems are known to have below ground geothermal fluid loops and above ground geothermal loops. The below ground loops enter steady temperature underground conditions (approximately, 55 degrees Fahrenheit) and, when used for cooling, hotter fluids sent down to the 55 degree level are cooled and returned to cool the above ground environment (e.g., inside the building or home), and when used for heating, cooler fluids sent down to the 55 degree level are heated and returned to heat the environment. Such cooling and heating processes often involve geothermal heat exchangers where a second fluid or air is used for the above ground heating/cooling loop. By utilizing dual purpose rebars in the present invention structural support members for man-made structures, such as buildings, runways, bridges and the like, the need for separate above ground geothermal loops is completely eliminated. These support members could be walls, ceilings, floors, walkways, bridgeways, runways, patios and other structures in need of heating and/or cooling. Hence, in the present invention support members, the dual use rebars add structural design value to the support (that is, they have significant added value to the vertical and/or other strength of the support), while at the same time providing one or more above ground geothermal system loops.

b. Description of Related Art

The following patents are representative of the field pertaining to the present invention:

U.S. Pat. No. 8,424,590 B2 to Calamaro describes a geothermal sleeve for a building structure that keeps air at a moderate temperature by passing through a geothermal heat exchanger (e.g., pipes) located underground. The moderate air is drawn up from the underground pipes and pumped into existing spaces between the interior and exterior walls (or surfaces) of a dwelling. The moderate air fills in the spaces between the interior and exterior walls to create a geothermal sleeve to supplement climate control inside the building structure.

U.S. Pat. No. 8,161,759 B2 to Kidwell et al. describes a method of and apparatus for transferring heat energy between a heat exchanging subsystem installed above the surface of the Earth, and material beneath the surface of the Earth, by installing one or more coaxial-flow heat exchanging structures in the material beneath the surface of the Earth. Each coaxial-flow heat exchanging structure has inner and out flow channels along which aqueous-based heat transfer fluid is circulated. Turbulence is generated in the aqueous-based heat transfer fluid flowing along the outer flow channel, to increase the rate of heat energy transfer between the aqueous-based heat transfer fluid and material beneath the surface of the Earth along the length of the outer flow channel. This in turn increases the rate of heat energy transfer between the heat exchanging subsystem installed above the surface of the Earth and material beneath the surface of the Earth.

U.S. Pat. No. 7,377,122 B2 to Kidwell et al. describes the coaxial-flow heat exchanging structures installed in the Earth, for facilitating the transfer of heat energy in the aqueous-based heat transfer fluid, between the aqueous-based heat transfer fluid and material beneath the surface of the Earth. Each coaxial-flow heat exchanging structure includes an inner tube section, a thermally conductive outer tube section, and outer flow channel between the inner tube section and the outer tube section. A turbulence generating structure is disposed along a portion of the length of the outer flow channel so as to introduce turbulence into the flow of the aqueous-based heat transfer fluid flowing along the outer flow channel, while its cross-sectional characteristics produce fluid flows therealong having optimal vortex characteristics that optimize heat transfer with the Earth.

U.S. Pat. No. 7,373,785 B2 to Kidwell et al. describes a geothermal heat exchanging system including a heat exchanging subsystem installed above the surface of Earth, and one or more coaxial-flow heat exchanging structures installed in the Earth. The coaxial-flow heat exchanging structures installed in the Earth, facilitate the transfer of heat energy in the aqueous-based heat transfer fluid, between the aqueous-based heat transfer fluid and material beneath the surface of the Earth. Each coaxial-flow heat exchanging structure includes an inner tube section, a thermally conductive outer tube section, and outer flow channel between the inner tube section and the outer tube section. A turbulence generating structure is disposed along a portion of the length of the outer flow channel so as to introduce turbulence into the flow of the aqueous-based heat transfer fluid flowing along the outer flow channel, thereby improving the transfer of heat energy between the aqueous-based heat transfer fluid and the Earth along the length of the outer flow channel.

U.S. Pat. No. 7,370,488 B2 to Kidwell et al. describes a geothermal heat exchanging system including a heat exchanging subsystem installed above the surface of Earth, and one or more coaxial-flow heat exchanging structures installed in the Earth. The coaxial-flow heat exchanging structures installed in the Earth, facilitate the transfer of heat energy in the aqueous-based heat transfer fluid, between the aqueous-based heat transfer fluid and material beneath the surface of the Earth. Each coaxial-flow heat exchanging structure includes an inner tube section, a thermally conductive outer tube section, and outer flow channel between the inner tube section and the outer tube section. A turbulence generating structure is disposed along a portion of the length of the outer flow channel so as to introduce turbulence into the flow of the aqueous-based heat transfer fluid flowing along the outer flow channel, thereby improving the transfer of heat energy between the aqueous-based heat transfer fluid and the Earth along the length of the outer flow channel.

U.S. Pat. No. 6,789,608 B1 to Wiggs describes a thermally exposed centrally insulated geothermal heat exchange unit, which can be placed in ground and/or in water, consisting of at least one fluid supply line and at least one fluid return line, which lines are respectively separated by a thermal insulation material, but which lines are otherwise in thermal contact with their respective adjacent sub-surface earth and/or water surroundings by means of a heat conductive fill material inserted as necessary to fill any void space in the respective fluid transport line location areas situated between the thermal insulation material and the adjacent earth and/or water. When the unit is situated within a geothermal borehole, the thermal insulation material may have an expanded central area so as to decrease the amount of necessary heat conductive fill and so as to increase insulation efficiency. The length of the insulation material within a borehole should be at least four times the diameter of the largest fluid transfer line, or lines, and should extend across the entire width of the borehole in all cases where the minimum design length is exceeded, unless a small width is left at each respective perimeter for the fill to seal out potentially corrosive elements. The width of the insulation material within a borehole should not exceed one-third the diameter of the borehole.

U.S. Pat. No. 6,672,371 B1 to Amerman et al. describes an earth wellbore heat loop system which has, in certain aspects, a heat loop wellbore in the earth extending from an earth surface down into the earth to a bottom of the wellbore, a heat loop disposed in the heat loop wellbore and extending down to a position near the bottom thereof, the heat loop including a heat loop comprising pipe and a bottom member, the pipe extending down to the bottom member on one side thereof and up from the bottom member on another side thereof, the bottom member comprising a body, a first bore through the body extending from a first opening of the body to a second opening of the body, the first opening and the second opening each sized and configured for receipt therein of an end of a heat loop pipe, a second bore having at least a one opening on the body, the second bore sized and configured for securement thereat of an end of coil tubing. Filler material has been developed for use in a heat loop wellbore that has, in certain aspects an amount of water, and an amount of a gel material, such as a polymer. An amount of thermally conductive solids may be used with the polymer and the water.

U.S. Pat. No. 6,450,247 B1 to Raff describes a system that uses a well drilled deep into the ground and filled with water. The well is encased and sealed at its bottom to prevent the loss of water. The casing of the well is in contact with the surrounding earth for heat conduction. A pipe is placed within the well with a pump at its distal end. The pump draws cold water from within the well into the pipe, out of the well into a heat exchanger where it cools the air which, in turn, cools the house. After the water has gone through the heat exchanger, it is returned to the well. Heat pipes are used to dissipate, in winter, the heat accumulated during the summer cooling months. The heat pipes extend outwardly from near the top of the well and contain a substance that will absorb heat and evaporate at the end in the well and condense and release heat at the opposite end. An upward slant of the heat pipe ensures that this heat transfer occurs only in the direction away from the well.

U.S. Pat. No. 5,816,314 to Wiggs et al. describes an improved geothermal heat exchange unit, which can be placed in ground and/or water, and has a rigid hollow core about which is formed a helical winding of thermally conductive tube. The return section of the tube extends vertically along a central axis of the core, separated from the inner wall of the core by thermal insulating material. The heat exchange unit is optionally encased in a solid thermally conductive casing and may have a small diameter oil return tube from the lowermost portion of the unit to the suction intake port of a gas compressor. An optional high pressure water hose is attached for installation assistance in wet sand or wet soils.

U.S. Pat. No. 4,566,527 to Pell et al. describes an isothermal heat pipe system for transferring heat from a primary fluid, such as geothermal water or steam, municipal water system, solar heated water, or the like, to another medium to be heated isothermally, such as a road or bridge deck surface, that includes an elongated enclosed chamber with a volatile liquid, such as ammonia or freon, contained therein, a heat exchanger tube positioned to run through the chamber in contact with the volatile liquid, and elongated distribution pipes connected in fluid-flow relation to and extending upwardly from the upper portion of the common chamber above the level of the volatile fluid and extending into divers portions of the medium to be heated in spaced-apart relation to each other in such a manner that there is a continuous downward gradient in each of the distributor tubes from the distal end thereof to the chamber. The primary heated fluid is circulated through the heat exchanger tubes, and a wick material is attached to the external surface of the heat exchanger tube to increase surface area for transfer of heat from the heated primary fluid in the heat exchanger tube to the volatile fluid in the chamber around the heat exchanger tube.

U.S. Pat. No. 4,162,394 to Faccini describes a dual mode heat pipe for roadways, bridges, etc., that includes an auxiliary evaporator formed concentrically with the upper end of a vertically disposed primary evaporator portion. The auxiliary evaporator portion comprises an annular sleeve disposed about the upper end of the primary evaporator portion and arranged between the primary evaporator portion and the condenser portion of the heat pipe such that all of the condensed working fluid returning to the primary evaporator portion must enter and overflow the auxiliary evaporator portion prior to return to the primary evaporator portion. The auxiliary evaporator portion is provided with heat input means whereby the auxiliary evaporator may function even in the absence of heat pipe function by the primary evaporator.

U.S. Pat. No. 4,050,509 to Bienert et al. describes down-pumping heat pipes provided to augment natural earth heat when used in association with conventional or up-pumping heat pipes for the purpose of maintaining an area such as a roadway free of ice and snow.

Notwithstanding the prior art, the present invention is neither taught nor rendered obvious thereby.

### SUMMARY OF INVENTION

The present invention is a support member for a man-made structure, the support member with a dual use rebars to function as both structural rebars and as geothermal underground loop segments. This present invention support member is at least partially above ground and includes a poured filler and at least two hollow rebars embedded within said poured filler thereby displacing a volume of the poured filler equal to the volume of the embedded at least two hollow rebars. The at least two hollow rebars includes a first hollow rebar, being a upward flow geothermal underground loop segment and having an inlet at one end, e.g., at its bottom for vertical structures such as walls, and includes a second hollow rebar, being an downward flow geothermal underground loop segment and having an outlet at one end, e.g., at its bottom. The at least two hollow rebars are connected to each other at their tops by a hollow connector to establish a geothermal above ground loop. Very importantly, the at least two hollow rebars have structural design support value sufficient to support load in excess of the poured filler which they displace. Unlike other loop segments for geothermal systems, in the present invention, the dual use rebars are thick enough and made of steel or similar material, to add engineering structural design support value to the structure to reduce dimensions of other load bearing components and/or add additional strength to the support member. Thus, they replace existing rebars that would otherwise be used and are as strong as or stronger than the rebars that they replace. The terms “upward flow” and downward flow” should be interpreted broadly to mean away from and back to the geothermal control system where is receives heat transfer from below ground, and the actual orientation is otherwise irrelevant. For example, in a wall the upward flow will literally be in an up direction and the downward flow will literally flow down. In a floor or ceiling, the upward flow might be across and away from the geothermal control system and the downward flow may be across and toward it. In other structures, the flows may be down, but might be in an arc to conform to the shape of a bridgeway (the roadway of a bridge, which may ramped up or down or both) or segment.

In some embodiments of the present invention support member for a man-made structure with dual use rebars, the poured filler is selected from the group consisting of cement, concrete, synthetic cement, polymer aggregate and combinations thereof.

In some embodiments of the present invention support member for a man-made structure with dual use rebars, the support member is selected from the group consisting of a floor, a wall, a ceiling, a sidewalk and a patio. In other embodiments, the support member is an outdoor structure for wheeled vehicles selected from the group consisting of a roadway, a runway, a bridge, a speedway and a parking lot. In these instances, the system is for heating above freezing to de-ice and melt snow to maintain vehicle safety.

In some embodiments of the present invention support member for a man-made structure with dual use rebars, the at least two hollow rebars are heat treated metal hollow rebars.

In some embodiments of the present invention support member for a man-made structure with dual use rebars, there are more than two hollow rebars and they are functionally connected to one another in series to allow continuous flow of a geothermal fluid. In some of these embodiments of the present invention support member for a man-made structure with dual use rebars, there is also a geothermal above ground conditioning system for creating at least one condition selected from heating and cooling, and having an geothermal above ground loop and a geothermal underground loop, and being connected to said inlet and said outlet of said first hollow rebar and said second hollow rebar, respectively to function as said above ground geothermal loop. In some of these embodiments, there is further a second support member for said man-made structure, the second support member with a dual use rebars to function as both structural rebars and as said geothermal underground loop segments. This includes said second support member being at least partially underground and including a poured filler and at least two underground hollow rebars embedded within said poured filler thereby displacing a volume of said poured filler equal to the volume of said embedded at least two underground hollow rebars, a first underground hollow rebar of said at least two underground hollow rebars being a downward flow geothermal underground loop segment and having an inlet at its top, and a second underground hollow rebar of said at least two underground hollow rebars being an upward flow geothermal underground loop segment and having an outlet at its top, said at least two underground hollow rebars being connected to each other at their bottoms by a hollow connector to establish a geothermal underground loop, and said at least two underground hollow rebars having structural design support sufficient to support load in excess of poured filler which they displace. In some of these embodiments, the support member is a piling and it has an outer casing that is a metal casing. In other embodiments, the support member is a caisson.

In some embodiments, the poured filler for the underground loop is selected from the group consisting of cement, concrete, synthetic cement, polymer aggregate and combinations thereof.

In some embodiments of the present invention support member for a man-made structure with dual use rebars as both the above ground and the underground geothermal loops, there are more than two hollow rebars and they are functionally connected to one another in series to allow continuous flow of a geothermal fluid.

The present invention also relates to methods of making the foregoing structures and support members. Thus, in some embodiments, the invention is a method for creating a support member for a man-made structure, which includes the following: (a) positioning a mold for said support structure for receiving poured filler; (b) inserting at least two hollow rebars into said mold that will displace a volume of said poured filler equal to the volume of said inserted at least two hollow rebars, including a first hollow rebar of said at least two hollow rebars, being a downward flow geothermal underground loop segment and having an inlet at its top, and a second hollow rebar of said at least two hollow rebars, being an upward flow geothermal underground loop segment and having an outlet at its top, said at least two hollow rebars being connected to each other at their bottoms by a hollow connector to establish a geothermal underground loop, and said at least two hollow rebars having structural design support sufficient to support load in excess of poured filler which they displace; (c) pouring a filler into said mold and around said at least two hollow rebars so as to embed said hollow rebars within said filler with tops of said first hollow rebar and said second hollow rebar extending beyond said filler for connection to a geothermal above ground conditioning system.

In some embodiments of the present invention method of creating a support member for a man-made structure, the filler is selected from the group consisting of cement, concrete, synthetic cement, polymer aggregate and combinations thereof. In some embodiments of the present invention method of creating a support member for a man-made structure, the at least two hollow rebars are heat treated metal hollow rebars. In some embodiments of the present invention method of creating a support member for a man-made structure, there are more than two hollow rebars inserted and they are functionally connected to one another in series to allow continuous flow of a geothermal fluid. In some embodiments of the present invention method of creating a support member for a man-made structure, the method further includes creating a second support member with dual use underground rebars to function as both structural rebars and as a geothermal underground loop segments, which includes: inserting a casing into the ground; inserting at least two underground hollow rebars into said casing that will displace a volume of said poured filler equal to the volume of said inserted at least two underground hollow rebars, including a first underground hollow rebar of said at least two underground hollow rebars, being a downward flow geothermal underground loop segment and having an inlet at its top, and a second underground hollow rebar of said at least two underground hollow rebars, being an upward flow geothermal underground loop segment and having an outlet at its top, said at least two underground hollow rebars being connected to each other at their bottoms by a hollow connector to establish a geothermal underground loop, and said at least two hollow rebars having structural design support sufficient to support load in excess of poured filler which they displace; pouring a filler into said casing and around said at least two hollow rebars so as to embed said hollow rebars within said filler with tops of said first hollow rebar and said second hollow rebar extending beyond said filler; and, connecting said above ground geothermal loop and said underground geothermal loop to geothermal above ground conditioning system for creating at least one condition selected from heating and cooling.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS(S)

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a block diagram of the present invention support member with dual use rebars used as above ground geothermal loops as well as structural value members;

FIG. 2 shows a front view of a present invention support member involving a wall with dual use rebars used as above ground geothermal loops as well as structural value members;

FIG. 3 shows a top view of a present invention support member involving a floor with dual use rebars used as above ground geothermal loops as well as structural value members;

FIG. 4 shows a bottom view of a present invention support member involving a ceiling with dual use rebars used as above ground geothermal loops as well as structural value members;

FIG. 5 shows a front cut view of a present invention structure from FIG. 2 or 3 or 4 above connected via geothermal pumps and controls to a piling with dual purpose rebars that serve to provide both structural design value as a rebar and to provide a below ground geothermal loop;

FIG. 6 shows a top oblique view of a section of a bridge (bridgeway) and caisson, the present invention support member being the bridgeway with dual use rebars in a horizontal orientation that function as both above ground geothermal loops as well as structural value members;

FIG. 7 shows an end view and partial block diagram wherein the present invention support member is both a section of a bridge (bridgeway) and the caisson, the bridgeway with dual use rebars in a horizontal orientation that function as both above ground geothermal loops as well as structural value members, such as in FIG. 6, and the caisson with vertical dual use hollow rebars that function as both below ground geothermal loops as well as structural value members;

FIG. 8 shows a block diagram of the present invention support member with dual use rebars wherein all of the dual use hollow rebars have structural value and some of the dual use hollow rebars also function as above ground geothermal loops while others function as below ground geothermal loops.

### DETAILED DESCRIPTION OF THE EMBODIMENTS

The present invention relates to geothermal conditioning systems for air conditioning, heating and combinations thereof, and more specifically to significant decreases in costs of installment, using environmentally preferred methods and arrangements. Geothermal heating/cooling systems have below ground geothermal fluid loops that are the receiving portion (receiving heat or cool from the ground) and above ground geothermal loops (dispersing heat or cool obtained from the receiving loops). The below ground loops move fluids from ground (or above ground) levels to below ground levels and back to take advantage of steady temperature underground conditions (approximately, 55 degrees Fahrenheit). The above ground loops distribute and disperse the cooling or warming fluids to the structure. (If the environment of the structure is cold, e.g., winter weather, then the 55 degree fluids in the above ground loops are heating, whereas if the environment is hot, e.g., Florida summers, then the 55 degree fluids in the above ground loops are cooling). By utilizing dual purpose rebars in the present invention above ground structure supports, such as walls, walkways, ceilings, floors, roadways, patios, runways and bridgeways and in some cases, additionally in below ground structural supports such as pilings and caissons, for buildings, roadways, homes, runways, bridges and other man-made structures, many advantages inure: (a) for above ground, separate piping for above ground loops are eliminated as are separate structural design rebars; (b) for below ground loops, the need for separate drillings, pipes and pourings for below ground geothermal loops is completely eliminated. In the present invention support members, the dual use rebars add structural design value to the support (that is, they have significant added value to the vertical and/or other strength of the support), while at the same time provide one or more above ground or combination above ground/below ground geothermal system loops. The term “above ground” as used herein means upstream from below ground loops and may physically be above ground level or not. Thus, a system having a below ground loop below a basement may have an above ground loop to heat the basement to 55 degrees or so yet the basement walls containing that above ground loop could physically be below ground level. However, in almost all cases the above ground loop is at least partially and often is completely above ground level. The term “below ground” as used herein is generally meant to be below ground level, but also includes at least partially below ground level and also includes below water level (which is usually inherently below ground level). It is used to refer to the loop that takes the effect of the below ground temperature from below ground to the above ground loop from above ground use. Typical geothermal loops are made of plastic, PVC, or metal pipes such as copper or aluminum and have little or no structural design value.

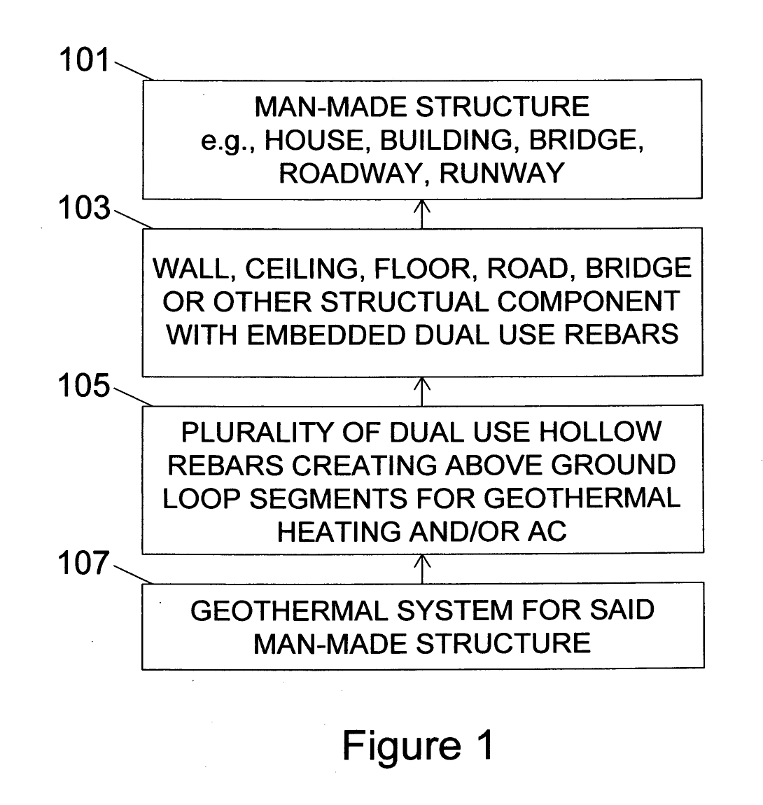

FIG. 1 shows a block diagram of the present invention support member with dual use rebars used as above ground geothermal loops as well as structural value members. Block 101 shows man-made structure e.g., house, building, bridge, roadway, runway or equivalent. A support member that is a part of the structure 101, such as shown in block 103, includes walls ceilings, floors, roadways, bridgeways, and similar structural members that have poured formations, such as concrete, cement or composite structures, and that normally contain rebars for design strength value. In block 105, a plurality of dual use hollow rebars creating above ground loop segments for geothermal heating and/or air conditioning are placed in the block 103 members wherein the poured filler embedded dual use hollow rebars are positioned at least partially above ground and are connected to a geothermal system 107 for the man-made structure 101. This block diagram of FIG. 1 illustrates the primary objective of the invention, which is to support structures that could contain the dispersing loop of a geothermal system with rebars that are both of genuine structural design value and function as heating and/or cooling geothermal above ground loops.

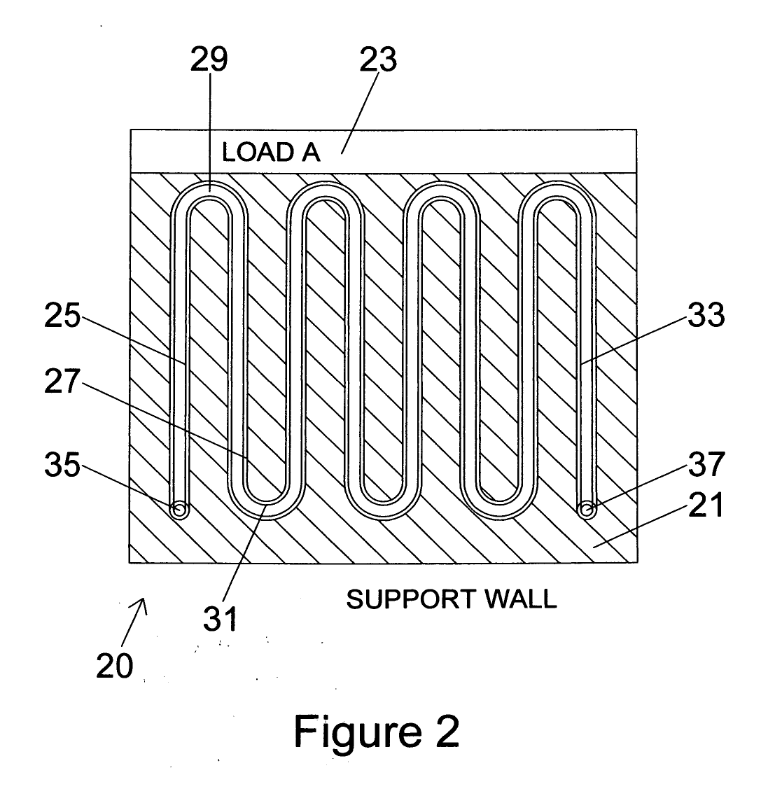

FIG. 2 shows a front view of a present invention support member 20. The support member 20 is a poured support wall 21 that would normally have conventional rebars to support the surroundings and particularly ceilings above (that may also serve as floors for another level of usage), designated here generally as load A and shown as ceiling 23. For decades, engineers have determined that loads such as Load A can be supported by smaller thickness walls if rebars are inserted that have structural design values greater than the filler excluded by the smaller cross-section (diameter) of the rebars. Thus, if a 12 inch thick wall of a particular poured filler has a structural design value of 26 tons, then an 8 inch thick wall of the same structure might have a structural design value of 15 tons. By inserting two 3 inch vertical rebars, each having a structural design value of 5.5 tons, the thinner 8 inch thick wall will have about the same structural design value as the 12 inch thick without rebars. Thus, the support capability of the 8 inch wall with the preceding stated two rebars will be as strong as the 12 inch wall mentioned (15+5.5+5.5=26 tons). By using these structural design values and building hollow rebars that have equal or more strength than the solid rebars, then dual use rebars are used to function as both rebars and geothermal loops.

Referring again back to FIG. 2, wall 21 has embedded therein a set of hollow rebars represented by first rebar 25, exemplary rebar 27 and last rebar 33, that have the dual function mentioned, i.e., they have structural support contributions to the support member (wall 21) and are used for (a portion or all of) an above ground geothermal loop. Thus, these rebars are in series and connected by U-connections or other piping, such as U-connections 29 and 31, so that the above ground loop fluid may enter at inlet 35 and exit at outlet 37. In this way, these dual use rebars provide additional structural support to the wall, allowing for thinner walls and less poured filler, and eliminate the need for separate geothermal loops. These loops may be connected directly or indirectly to the below ground loops with proper controls and may utilize heat exchangers, as the design of the controls and flow rates to achieve desired possible temperatures is well within the skill of the artisan in the geothermal systems industry.

It is an objective of the present invention to create dual purpose rebars having beneficial structural design value to achieve four favorable results simultaneously: (a) reduce the cross sections or other dimensions of support structures by inclusion of rebars having structural design values; (b) use hollow rebars for the aforesaid rebars, that also function as geothermal loops, i.e., flow paths for above ground geothermal loop fluids; (c) thereby eliminate any separate fixtures, pipes or fillings for geothermal above ground loops; (d) by eliminating the standard separate geothermal loops, reducing costs and environmental and aesthetic impacts that otherwise would have occurred.

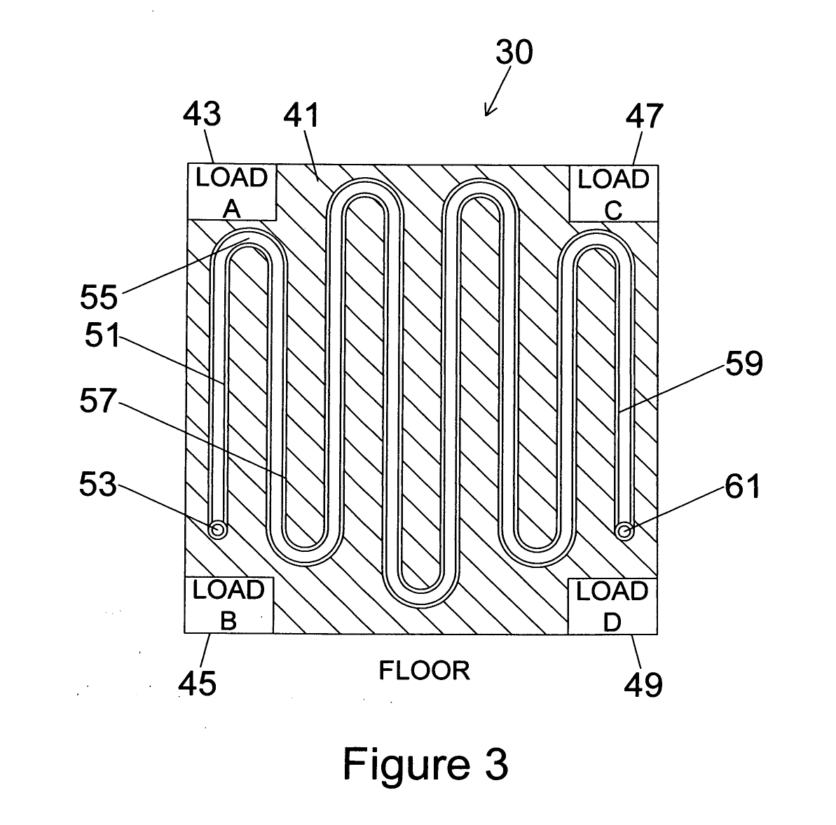

FIG. 3 shows a top view of a present invention support member 30. The support member 30 is a poured support floor 31 that would normally have conventional rebars to support the surroundings and particularly the floor itself, as well as loads such as columns 43, 45, 47 and 49, shown as Loads A, B, C and D respectively. Floor 41 has embedded therein a set of hollow rebars represented by first rebar 51, exemplary rebar 57 and last rebar 59, that have the dual function mentioned, i.e., they have structural support contributions to the support member (floor 31) and are used for (a portion or all of) an above ground geothermal loop. Thus, these rebars are in series and connected by U-connections or other piping, such as U-connection 55, so that the above ground loop fluid may enter at inlet 53 and exit at outlet 61. In this way, these dual use rebars provide additional structural support to the floors with their structural design values, allowing for stronger and/or thinner floors and less poured filler, and they eliminate the need for separate geothermal loops.

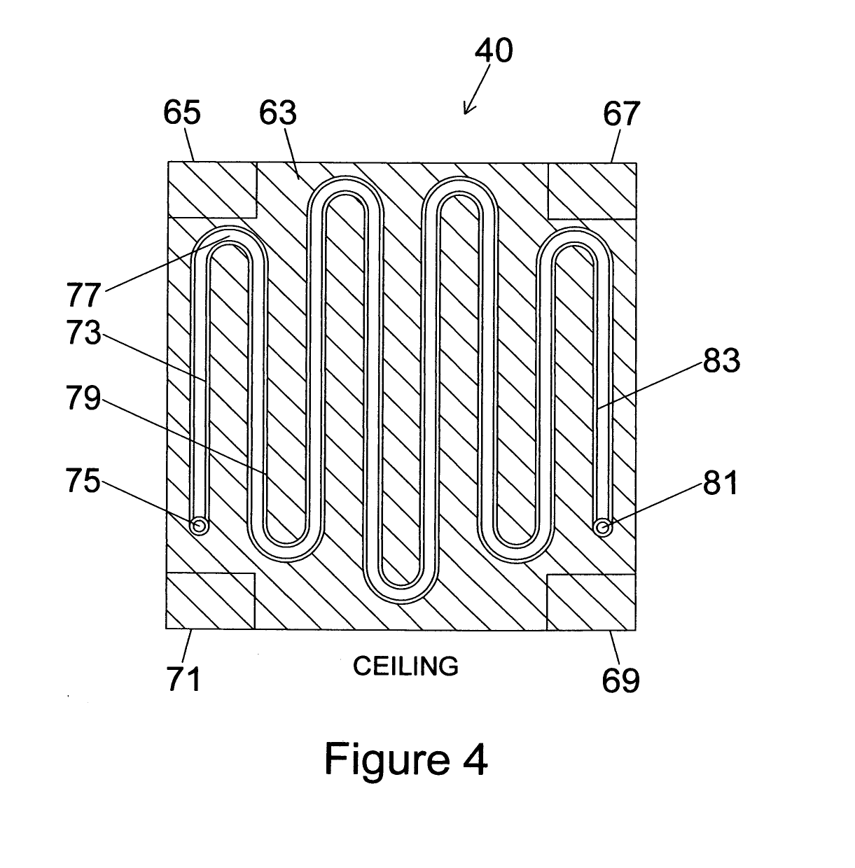

FIG. 4 shows a bottom view of a present invention support member 40. The support member 40 is a poured ceiling 63 that would normally have conventional rebars to support the surroundings and particularly the ceiling itself, as well as loads such as columns 65, 67, 69 and 71. Ceiling 63 has embedded therein a set of hollow rebars represented by first rebar 73, exemplary rebar 79 and last rebar 83, that have the dual function mentioned, i.e., they have structural support contributions to the support member (ceiling 63) and are used for (a portion or all of) an above ground geothermal loop. Thus, these rebars are in series and connected by U-connections or other piping, such as U-connection 77, so that the above ground loop fluid may enter at inlet 75 and exit at outlet 81. These dual use rebars provide additional structural support to the ceilings with their structural design values, allowing for stronger and/or thinner ceilings and less poured filler, and they eliminate the need for separate geothermal loops.

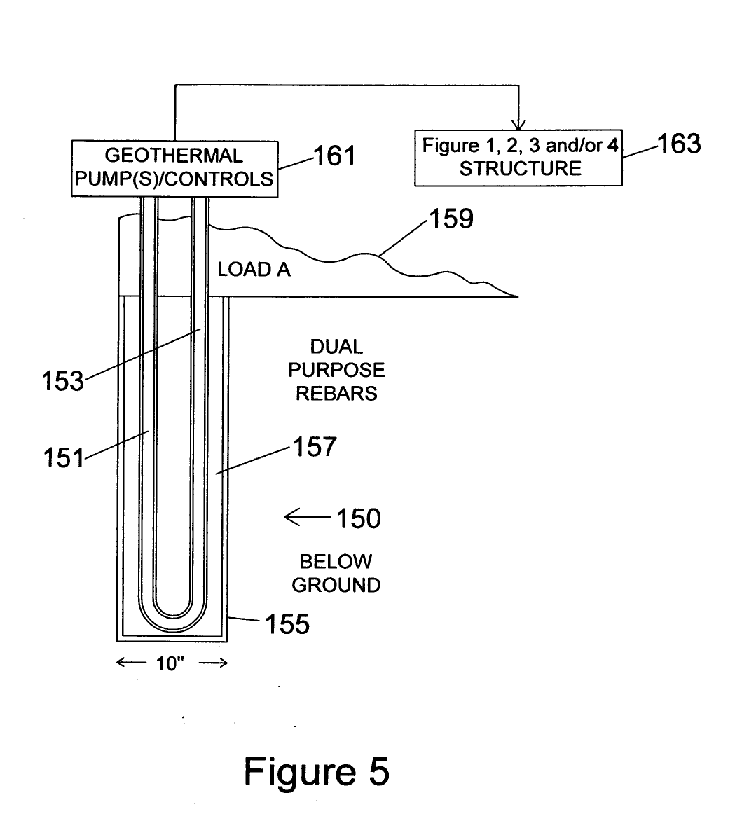

FIG. 5 shows a front cut view of a present invention structure 155 utilizing both above ground and below ground geothermal loops within present invention support members with hollow rebars. As shown in FIG. 5, block 163 incorporates present invention structural support members from FIG. 2 or 3 or 4 above connected via geothermal pumps and controls (block 161) to a piling 157 with casing 155 and specifically to embedded dual purpose rebars 151 and 153 that serve to provide both structural design value as a rebar and to provide a below ground geothermal loop.

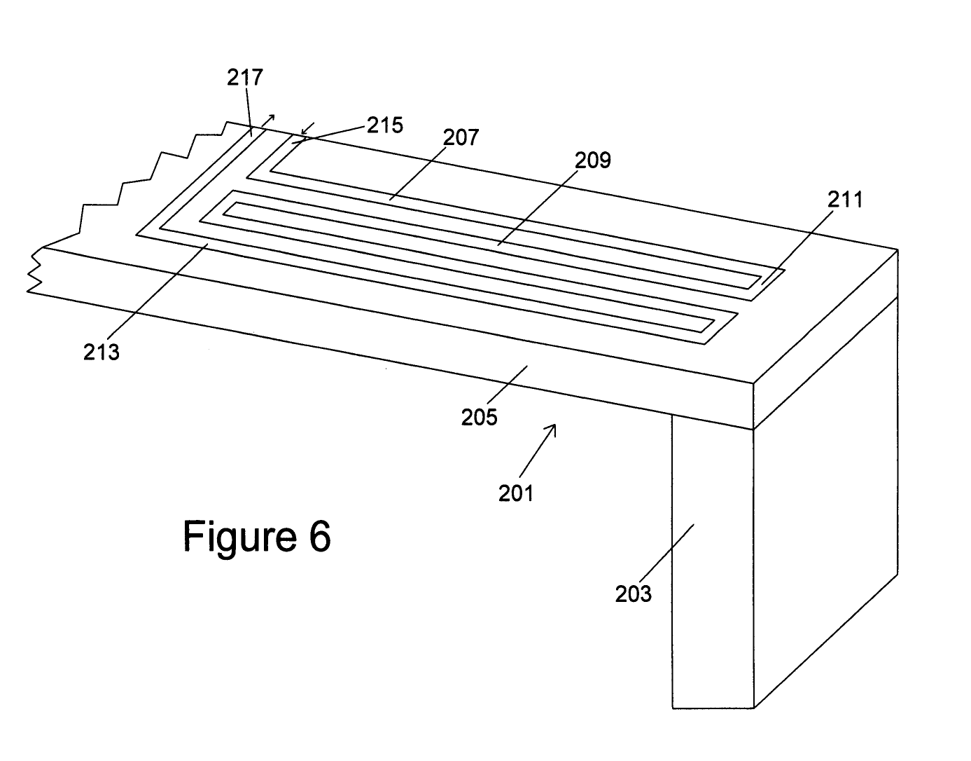

FIG. 6 shows a partial cut top oblique view of a section of a bridge 201 (also referred to herein as a bridgeway) and caisson 203, the present invention support member being the bridgeway with dual use rebars, such as rebars 207, 209 and 213, with connectors such as connector 211, in a horizontal orientation. As in other embodiments set forth above, these rebars function as both above ground geothermal loops and as structural value members (rebars). For illustration purposes, inlet 215 and outlet 217 are provided. These may be connected to manifolds or directly to geothermal heat exchangers or to other bridge sections, as any particular design criteria may dictate to maintain the bridgeway in a unfrozen state during winter exposure (e.g., length of span, historical cold temperatures, 100 year chill prediction, rebar diameters, flow rates, etc.).

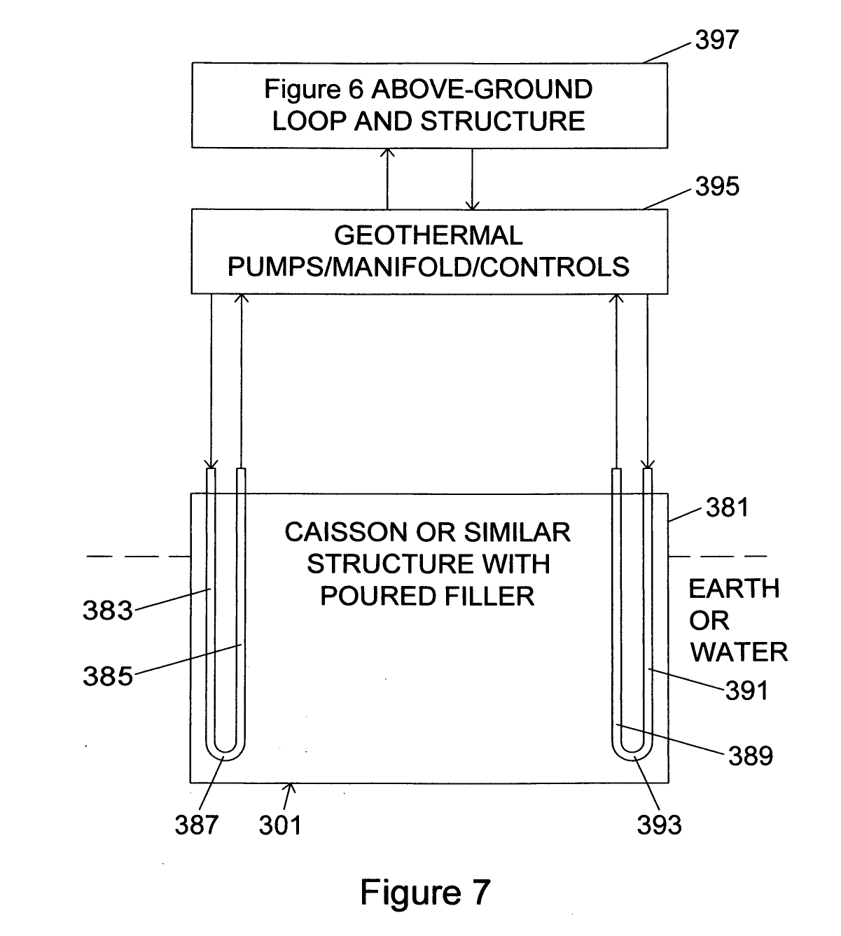

FIG. 7 shows an end view and partial block diagram wherein the present invention support member is both a section of a bridge (bridgeway), specifically, the FIG. 6 above-ground geothermal loop within the structure, here, block 397 and the caisson 301. In FIG. 6, the present invention support member is the bridgeway with dual use rebars in a horizontal orientation that function as both above ground geothermal loops as well as structural value members. In this FIG. 7, the FIG. 6 above-ground loop is connected to the geothermal functional (mechanical, electronic) system block 395, namely, geothermal pumps, optional manifold and essential controls for temperature and geothermal fluid flow control. Caisson 301 is a poured support member to support the FIG. 6 type structures, and its filler 381 has vertical dual use hollow rebars, including rebars 383 and 385 connected by connector 387 andrebars 389 and 391 connected by connector 393, all of which are connected to inlets and outlets from and to the functional system of block 395, and all of which function as both below ground geothermal loops as well as structural value members to increase the support strength of caisson or similar structure 301.

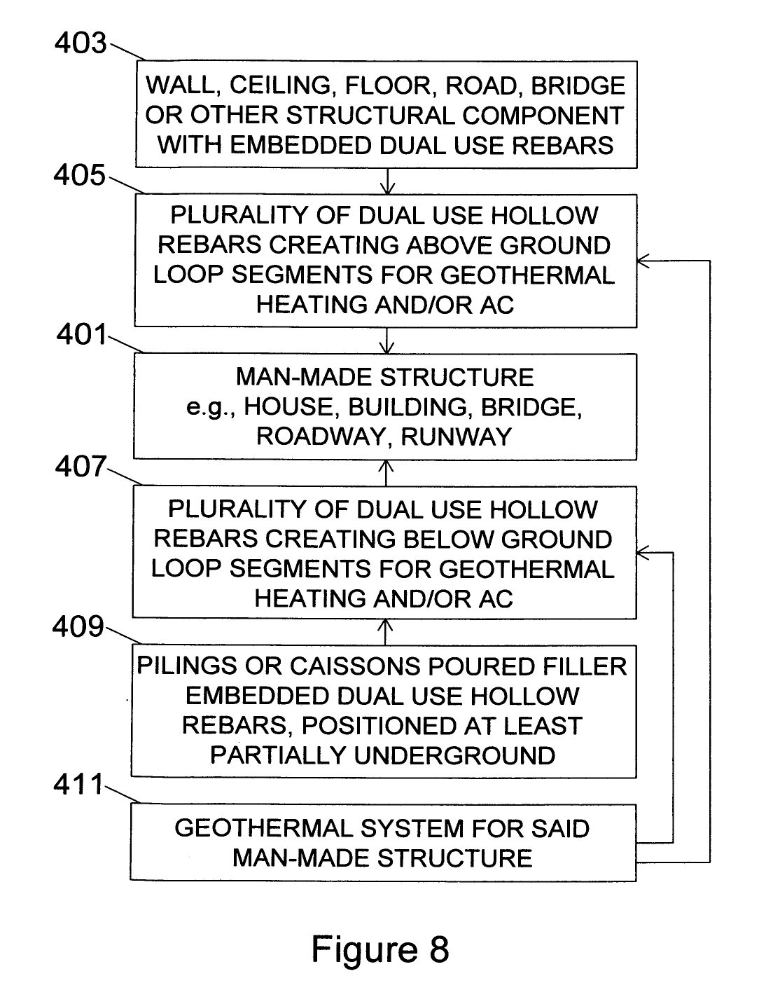

FIG. 8 shows a block diagram of the present invention support member with dual use rebars wherein all of the dual use hollow rebars have structural value and some of the dual use hollow rebars also function as above ground geothermal loops while others function as below ground geothermal loops. Thus, in FIG. 8, block 401 shows man-made structure e.g., house, building, bridge, roadway, runway or equivalent. A support member that is a part of the structure 401, such as shown in block 403, and includes walls ceilings, floors, roadways, bridgeways, and similar structural support members that have poured formations, such as concrete, cement or composite structures, and that normally contain rebars for design strength value. In block 405, a plurality of dual use hollow rebars creating above ground loop segments for geothermal heating and/or air conditioning are placed in the block 403 members wherein the poured filler embedded dual use hollow rebars are positioned at least partially above ground and are connected to a geothermal system 411 for the man-made structure 401. This block diagram of FIG. 8 illustrates the primary objective of the invention, which is to support structures that could contain the dispersing loop of a geothermal system with rebars that are both of genuine structural design value and function as heating and/or cooling geothermal above ground loops, but in addition, further includes in combination, the below ground improvements as set forth in the parent application of the present application. Specifically, in block 407, a plurality of dual use hollow rebars creating below ground loop segments for geothermal heating and/or air conditioning are placed in pilings or caissons 409 wherein the poured filler embedded dual use hollow rebars are positioned at least partially underground and connected to geothermal system 411 for the man-made structure 401 and in cooperation with the aforesaid above ground loops, provide heating to prevent icing and freezing and/or provide cooling to structure 401.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, when the poured support members are crated, there are three possibilities: (a) they are prefabricated and brought to the site with the dual function rebars in place at the time of fabrication; (b) some of the fabrication is preformed and the finishing occurs on site; or (c) the entire structure is made on site. Also, for example, when pilings are used as part of the present invention support structure, the casings may be partially or completely eliminated or substituted, and thus the term “casing” should mean any outer structure used to contain poured filler in a piling. Such casings may be corrugated tubing or other tubing or even box frames such as are used for pouring square pillars (pilings). Also, as in the situation wherein there is drilled bedrock at the bottom of the piling, a casing need not extend into the bedrock, whereas the poured filler will, and the dual purpose hollow rebars may or may not extend into the bedrock. Also, the term “piling” as used herein means any vertically elongated support member that is at least partially below ground and should be taken to be synonymous with “pile”.

What is claimed is:

1. A support member for a man-made structure, the support member with dual use rebars to function as both structural rebars and as geothermal above ground loop segments, which comprises:
said support member being at least partially above ground and including a poured filler and at least two hollow rebars embedded within said poured filler thereby displacing a volume of said poured filler equal to the volume of said embedded at least two hollow rebars, a first hollow rebar of said at least two hollow rebars being a upward flow geothermal above ground loop segment and having an inlet at one end, and a second hollow rebar of said at least two hollow rebars being an downward flow geothermal above ground loop segment and having an outlet at one end, said at least two hollow rebars being connected to each other at their opposite ends away from said inlet and outlet by a hollow connector to establish a geothermal above ground loop, and said at least two hollow rebars having structural design support value sufficient to support load in excess of poured filler which they displace.

2. The support member with dual use rebars of claim 1 wherein said poured filler is selected from the group consisting of cement, concrete, synthetic cement, polymer aggregate and combinations thereof.

3. The support member with dual use rebars of claim 1 wherein said support member is selected from the group consisting of a floor, a wall, a ceiling, a sidewalk and a patio.

4. The support member with dual use rebars of claim 1 wherein said support member is an outdoor structure for wheeled vehicles selected from the group consisting of a roadway, a runway, a bridge, a speedway and a parking lot.

5. The support member with dual use rebars of claim 1 wherein said at least two hollow rebars are heat treated metal hollow rebars.

6. The support member with dual use rebars of claim 1 wherein there are more than two hollow rebars and they are functionally connected to one another in series to allow continuous flow of a geothermal fluid.

7. The support member with dual use rebars of claim 1 wherein there is also a geothermal above ground conditioning system for creating at least one condition selected from heating and cooling, and having an geothermal above ground loop and a geothermal underground loop, and being connected to said inlet and said outlet of said first hollow rebar and said second hollow rebar, respectively to function as said above ground geothermal loop.

8. The support member with dual use rebars of claim 7 wherein there is further a second support member for said man-made structure, the second support member with a dual use rebars to function as both structural rebars and as said geothermal underground loop segments, which includes:
said second support member being at least partially underground and including a poured filler and at least two underground hollow rebars embedded within said poured filler thereby displacing a volume of said poured filler equal to the volume of said embedded at least two underground hollow rebars, a first underground hollow rebar of said at least two underground hollow rebars being a downward flow geothermal underground loop segment and having an inlet at its top, and a second underground hollow rebar of said at least two underground hollow rebars being an upward flow geothermal underground loop segment and having an outlet at its top, said at least two underground hollow rebars being connected to each other at their bottoms by a hollow connector to establish a geothermal underground loop, and said at least two underground hollow rebars having structural design support sufficient to support load in excess of poured filler which they displace.

9. The support member with dual use rebars of claim 8 wherein said poured filler is selected from the group consisting of cement, concrete, synthetic cement, polymer aggregate and combinations thereof.

10. The support member with dual use rebars of claim 8 wherein said support member is a piling.

11. The support member with dual use rebars of claim 10 wherein said piling has an outer casing and said outer casing is a metal casing.

12. The support member with dual use rebars of claim 8 wherein said support member is a caisson.

13. The support member with dual use rebars of claim 8 wherein said at least two underground hollow rebars are heat treated metal hollow rebars.

14. The support member with dual use rebars of claim 8 wherein there are more than two hollow rebars and they are functionally connected to one another in series to allow continuous flow of a geothermal fluid.

15. A method for creating a support member for a man-made structure, which comprises:
a) positioning a mold for said support structure for receiving poured filler;
b) inserting at least two hollow rebars into said mold that will displace a volume of said poured filler equal to the volume of said inserted at least two hollow rebars, including a first hollow rebar of said at least two hollow rebars, being an upward flow geothermal underground loop segment and having an inlet at one end, and a second hollow rebar of said at least two hollow rebars, being a downward flow geothermal underground loop segment and having an outlet at one end, said at least two hollow rebars being connected to each other at their ends opposite from said inlet and outlet by a hollow connector to establish a geothermal above ground loop, and said at least two hollow rebars having structural design support sufficient to support load in excess of poured filler which they displace;
c) pouring a filler into said mold and around said at least two hollow rebars so as to embed said hollow rebars within said filler with tops of said first hollow rebar and said second hollow rebar extending beyond said filler for connection to a geothermal above ground conditioning system.

16. The method of creating a support member for a man-made structure of claim 15 wherein said filler is selected from the group consisting of cement, concrete, synthetic cement, polymer aggregate and combinations thereof.

17. The method of creating a support member for a man-made structure of claim 15 wherein said at least two hollow rebars are heat treated metal hollow rebars.

18. The method of creating a support member for a man-made structure of claim 15 wherein there are more than two hollow rebars inserted and they are functionally connected to one another in series to allow continuous flow of a geothermal fluid.

19. The method of creating a support member for a man-made structure of claim 15 that further includes creating a second support member with dual use underground rebars to function as both structural rebars and as a geothermal underground loop segments, which includes:
d) inserting a casing into the ground;
inserting at least two underground hollow rebars into said casing that will displace a volume of said poured filler equal to the volume of said inserted at least two underground hollow rebars, including a first underground hollow rebar of said at least two underground hollow rebars, being a downward flow geothermal underground loop segment and having an inlet at its top, and a second underground hollow rebar of said at least two underground hollow rebars, being an upward flow geothermal underground loop segment and having an outlet at its top, said at least two underground hollow rebars being connected to each other at their bottoms by a hollow connector to establish a geothermal underground loop, and said at least two hollow rebars having structural design support sufficient to support load in excess of poured filler which they displace;
e) pouring a filler into said casing and around said at least two hollow rebars so as to embed said hollow rebars within said filler with tops of said first hollow rebar and said second hollow rebar extending beyond said filler; and,
f) connecting said above ground geothermal loop and said underground geothermal loop to geothermal above ground conditioning system for creating at least one condition selected from heating and cooling.

20. The method of creating a support member for a man-made structure of claim 19 wherein said filler is selected from the group consisting of cement, concrete, synthetic cement, polymer aggregate and combinations thereof.
